(19) United States
(12) Patent Application Publication
(10) Pub. No.: US 2025/0117279 A1
(43) Pub. Date: Apr. 10, 2025

(54) ELECTRONIC DEVICE, MANAGEMENT SERVER, AND CONTROL METHOD THEREOF

(71) Applicants: Hyundai Motor Company, Seoul (KR); Kia Corporation, Seoul (KR)

(72) Inventor: Sung Hwan Jun, Hwaseong-si (KR)

(21) Appl. No.: 18/735,385

(22) Filed: Jun. 6, 2024

(30) Foreign Application Priority Data
Oct. 4, 2023 (KR) 10-2023-0131866

(51) Int. Cl. G06F 11/07; G06F 8/65; G06F 11/14; H04L 9/40

(52) U.S. Cl. CPC G06F 11/0784; G06F 8/65; G06F 11/0787; G06F 11/1433; H04L 63/0442; H04L 63/123

(57) ABSTRACT

An electronic device includes a memory that stores computer-executable instructions and at least one processor that accesses the memory and executes the instructions, wherein the at least one processor may allocate a first target area to a memory of a target controller at a start point in time when over-the-air (OTA) programming is performed in the target controller by a main controller, store an OTA log containing a communication record between the target controller and the main controller in the first target area, and apply the OTA log to an encryption model and transmit an encrypted OTA log to the management server based on failure of the OTA at an end point in time when the OTA performed in the target controller ends.

### CROSS-REFERENCE TO RELATED APPLICATIONS

This application claims the benefit of priority to Korean Patent Application No. 10-2023-0131866, filed in the Korean Intellectual Property Office on Oct. 4, 2023, the entire contents of which are incorporated herein by reference.

### TECHNICAL FIELD

The present disclosure relates to an electronic device, a management server, and control methods thereof, and more specifically, to a technology for recording over-the-air (OTA) logs.

### BACKGROUND

Conventionally, when the OTA which is field-deployed has failed, it is possible to simply identify the success or failure of each phase of OTA using log history recorded on a server and the only way to cope with OTA failure is to check the status of a customer's vehicle.

In this way, a lot of manpower has been consumed before the same symptoms occur by performing actual vehicle reproduction evaluation for OTA failures that occur intermittently. Conventional measures for OTA failures is to find out the root cause of OTA failures by checking the presence or absence of failure for each phase only through server logs, or by directly obtaining the customer's vehicle, checking the vehicle's condition, and repeatedly performing numerous tests until the same symptoms occur with the test vehicle, thereby suffering many difficulties.

To solve the problems, there is a need to development of a technology for storing standardized OTA logs through standardization of OTA logs by transmitting standardized OTA logs to a management server such that the control server quickly finds out the cause of OTA failure merely through log analysis and promote rapid improvement of a controller.

### SUMMARY

The present disclosure has been made to solve the above-mentioned problems occurring in the prior art while advantages achieved by the prior art are maintained intact.

An aspect of the present disclosure provides an electronic device, a management server, and control methods thereof, capable of storing OTA logs in a target area allocated to a memory of a target controller, and analyzing the cause of OTA failure in a faster time without the need to conduct unlimited real-time reproduction evaluation of OTA failure events, thereby achieving additional improvements in OTA deployment.

An aspect of the present disclosure provides an electronic device, a management server, and control methods thereof, capable of minimizing the possibility of hacking through communication of encrypted data between network nodes in view of a vehicle security by transmitting encrypted OTA logs to the management server based on OTA failure at the end point in time when OTA ends.

An aspect of the present disclosure provides an electronic device, a management server, and control methods thereof, capable of enabling rapid cause analysis without the need for continuous vehicle reproduction evaluation by storing a vehicle's power information, task information, and control information in a target area, and reducing a period during which customers are unable to download new software.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, an electronic device includes a memory that stores computer-executable instructions and at least one processor that accesses the memory and executes the instructions, wherein the at least one processor may allocate a first target area to a memory of a target controller at a start point in time when OTA programming is performed in the target controller by a main controller, store an OTA log containing a communication record between the target controller and the main controller in the first target area, and apply the OTA log to an encryption model and transmit an encrypted OTA log to the management server based on failure of the OTA at an end point in time when the OTA performed in the target controller ends.

According to an embodiment, the at least one processor may allocate a second target area different from the first target area to a memory of the main controller at the start point in time when the OTA is performed, determine at least one of the first target area, or the second target area, or any combination thereof as an area for storing the OTA log, before performing communication between the target controller and the main controller, and store the OTA log in the determined area.

According to an embodiment, the at least one processor may obtain status information including at least one of power information of a vehicle including the target controller, OTA task information, or control information of the target controller, or any combination thereof, and store the status information and the OTA log in the first target area.

According to an embodiment, the at least one processor may determine whether the OTA is successful, based on at least one of a log of download phase, a log of background transfer phase, a log of update phase, or a log of OTA end phase, or any combination thereof, which is included in the OTA log at the end point in time when the OTA ends, and delete the OTA log stored in the first target area based on the OTA being successful at the end point in time when the OTA ends.

According to an embodiment, the at least one processor may apply the OTA log to the encryption model to obtain a first encrypted OTA log included in the encrypted OTA log and to which a public key encryption algorithm has been applied based on the OTA failing and the OTA log being stored, and transmit the first encrypted OTA log to the management server through the main controller.

According to an embodiment, the at least one processor may apply the OTA log to the encryption model to obtain a second encrypted OTA log included in the encrypted OTA log and to which a hash encryption algorithm has been applied based on the OTA failing and the OTA log being stored, and transmit the second encrypted OTA log to the management server through the main controller.

According to an embodiment, the at least one processor may combine an electronic signature capable of verifying integrity with at least one of the first encrypted OTA log, or the second encrypted OTA log, or any combination thereof.

According to an aspect of the present disclosure, a management server includes a memory that stores computer-executable instructions, at least one processor that accesses the memory and executes the instructions, and a communication device that performs communication with an electronic device, wherein the at least one processor may verify integrity of an encrypted OTA log based on an electronic signature combined with the encrypted OTA log based on receiving the encrypted OTA log from the electronic device, verify an access authority of a user who has entered a request for decryption of the encrypted OTA log based on receiving the request for decryption, and store the encrypted OTA log based on the integrity of the encrypted OTA log having been verified.

According to an embodiment, the at least one processor may obtain an OTA log by performing decryption of the encrypted OTA log based on the access authority of the user based on the access authority of the user having been verified.

According to an embodiment, the at least one processor may obtain status information of a target controller corresponding to the OTA log and a communication record between the target controller and the main controller which are included in the OTA log, and provide a cause of failure of OTA in the target controller to the user in response to the request for decryption based on the status information of the target controller and the communication record.

According to an aspect of the present disclosure, A control method includes allocating a first target area to a memory of a target controller at a start point in time when performing OTA programming in the target controller by a main controller, storing an OTA log containing a communication record between the target controller and the main controller in the first target area, and applying the OTA log to an encryption model and transmitting an encrypted OTA log to the management server based on failure of the OTA at an end point in time when the OTA performed in the target controller ends.

According to an embodiment, the allocating of the first target area may include allocating a second target area different from the first target area to a memory of the main controller at the start point in time when the OTA is performed, determining at least one of the first target area, or the second target area, or any combination thereof as an area for storing the OTA log, before performing communication between the target controller and the main controller, and storing the OTA log in the determined area.

According to an embodiment, the storing of the OTA log may include obtaining status information including at least one of power information of a vehicle including the target controller, OTA task information, or control information of the target controller, or any combination thereof, and storing the status information and the OTA log in the first target area.

According to an embodiment, the storing of the OTA log may include determining whether the OTA is successful, based on at least one of a log of download phase, a log of background transfer phase, a log of update phase, or a log of OTA end phase, or any combination thereof, which is included in the OTA log at the end point in time when the OTA ends, and deleting the OTA log stored in the first target area based on the OTA being successful at the end point in time when the OTA ends.

According to an embodiment, the transmitting of the encrypted OTA log to the management server may include applying the OTA log to the encryption model to obtain a first encrypted OTA log included in the encrypted OTA log and to which a public key encryption algorithm has been applied based on the OTA failing and the OTA log being stored, and transmitting the first encrypted OTA log to the management server through the main controller.

According to an embodiment, the control method may further include applying the OTA log to the encryption model to obtain a second encrypted OTA log included in the encrypted OTA log and to which a hash encryption algorithm has been applied based on the OTA failing and the OTA log being stored; and transmitting the first encrypted OTA log to the management server through the main controller.

According to an embodiment, the control method may further include combining an electronic signature capable of verifying integrity with at least one of the first encrypted OTA log, or the second encrypted OTA log, or any combination thereof.

According to an embodiment, the control method may further include verifying integrity of the encrypted OTA log based on an electronic signature combined with the encrypted OTA log based on receiving the encrypted OTA log from an electronic device, verifying an access authority of a user who has entered a request for decryption of the encrypted OTA log based on receiving the request for decryption, and storing the encrypted OTA log based on the integrity of the encrypted OTA log having been verified.

According to an embodiment, the verifying of the access authority of the user may include obtaining an OTA log by performing decryption of the encrypted OTA log based on the access authority of the user based on the access authority of the user having been verified.

According to an embodiment, the obtaining of the OTA log may include obtaining status information of a target controller corresponding to the OTA log and a communication record between the target controller and the main controller which are included in the OTA log, and providing a cause of failure of OTA in the target controller to the user in response to the request for decryption based on the status information of the target controller and the communication record.

### BRIEF DESCRIPTION OF THE DRAWINGS

The above and other objects, features and advantages of the present disclosure will be more apparent from the following detailed description taken in conjunction with the accompanying drawings:

FIG. 1 is a view showing an electronic device according to an embodiment of the present disclosure;

FIG. 2 is a flowchart showing a method of recording an OTA log according to an embodiment of the present disclosure;

FIG. 3 is a diagram illustrating an electronic device, a management server, an execution controller, and a main controller according to an embodiment of the present disclosure;

FIG. 4 is a flowchart for describing a method for recording an OTA log in an electronic device according to an embodiment of the present disclosure;

FIG. 5 is a flowchart for describing a method of decrypting an encrypted OTA log in a management server according to an embodiment of the present disclosure; and

FIG. 6 shows a computing system related to an electronic device, a management server, a control method therefor according to an embodiment of the present disclosure.

In the description of the drawings, the same or similar reference numerals may be used for the same or similar components.

### DETAILED DESCRIPTION

Hereinafter, some embodiments of the present disclosure will be described in detail with reference to the exemplary drawings. In adding the reference numerals to the components of each drawing, it should be noted that the identical or equivalent component is designated by the identical numeral even when they are displayed on other drawings. Further, in describing the embodiment of the present disclosure, a detailed description of well-known features or functions will be ruled out in order not to unnecessarily obscure the gist of the present disclosure. Hereinafter, various embodiments of the disclosure may be described with reference to accompanying drawings. However, this is not intended to limit the technology described herein to specific embodiments, and those of ordinary skill in the art will recognize that modifications, equivalents, and/or alternatives on the various embodiments described herein can be variously made without departing from the scope and spirit of the disclosure. With regard to description of drawings, similar components may be marked by similar reference numerals.

In describing the components of the embodiment according to the present disclosure, terms such as first, second, “A”, “B”, (a), (b), and the like may be used. These terms are merely intended to distinguish one component from another component, and the terms do not limit the nature, sequence or order of the constituent components. Unless otherwise defined, all terms used herein, including technical or scientific terms, have the same meanings as those generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application. For example, The terms, such as “first”, “second”, and the like used in the disclosure may be used to refer to various components regardless of the order and/or the priority and to distinguish the relevant components from other components, but do not limit the components. For example, “a first user device” and “a second user device” indicate different user devices regardless of the order or priority. For example, without departing the scope of the disclosure, a first component may be referred to as a second component, and similarly, a second component may be referred to as a first component.

In the disclosure, the expressions “have”, “may have”, “include” and “comprise”, or “may include” and “may comprise” used herein indicate existence of corresponding features (e.g., components such as numeric values, functions, operations, or parts) but do not exclude presence of additional features.

It will be understood that when an component (e.g., a first component) is referred to as being “(operatively or communicatively) coupled with/to” or “connected to” another component (e.g., a second component), it may be directly coupled with/to or connected to the other component or an intervening component (e.g., a third component) may be present. In contrast, when an component (e.g., a first component) is referred to as being “directly coupled with/to” or “directly connected to” another component (e.g., a second component), it should be understood that there are no intervening component (e.g., a third component).

According to the situation, the expression “configured to” used in the disclosure may be used as, for example, the expression “suitable for”, “having the capacity to”, “designed to”, “adapted to”, “made to”, or “capable of”.

The term “configured to” must not mean only “specifically designed to” in hardware. Instead, the expression “a device configured to” may mean that the device is “capable of” operating together with another device or other parts. For example, a “processor configured to (or set to) perform A, B, and C” may mean a dedicated processor (e.g., an embedded processor) for performing a corresponding operation or a generic-purpose processor (e.g., a central processing unit (CPU) or an application processor) which performs corresponding operations by executing one or more software programs which are stored in a memory device. Terms used in the disclosure are used to describe specified embodiments and are not intended to limit the scope of the disclosure. The terms of a singular form may include plural forms unless otherwise specified. All the terms used herein, which include technical or scientific terms, may have the same meaning that is generally understood by a person skilled in the art. It will be further understood that terms, which are defined in a dictionary and commonly used, should also be interpreted as is customary in the relevant related art and not in an idealized or overly formal unless expressly so defined in various embodiments of the disclosure. In some cases, even if terms are terms which are defined in the disclosure, they may not be interpreted to exclude embodiments of the disclosure.

In the disclosure, the expressions “A or B”, “at least one of A or/and B”, or “one or more of A or/and B”, and the like may include any and all combinations of one or more of the associated listed items. For example, the term “A or B”, “at least one of A and B”, or “at least one of A or B” may refer to all of the case (1) where at least one A is included, the case (2) where at least one B is included, or the case (3) where both of at least one A and at least one B are included. In addition, in describing the components of embodiments of the present disclosure, “each of phrases such as “A or B”, “at least one of A and B”, “at least one of A or B”, “A, B or C”, “at least one of A, B and C,” “at least one of A, B, or C,” and “at least one of A, B, or C, or any combination thereof” may include any one of, or all possible combinations of the items enumerated together in a corresponding one of the phrases. In particular, the phrase such as “at least one of A, B, or C, or any combination thereof” may include A or B or C or a combination thereof such as AB or ABC.

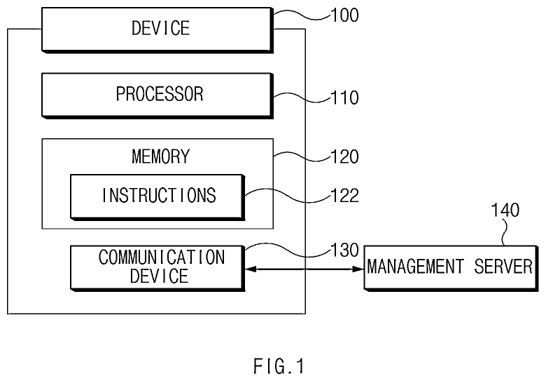

Hereinafter, embodiments of the present disclosure will be described in detail with reference to FIGS. 1 to 6.

FIG. 1 is a diagram showing an electronic device according to an embodiment of the present disclosure.

An electronic device 100 according to an embodiment may include a processor 110, a memory 120 configured to store instructions 122, and a communication device 130.

The electronic device 100 may refer to a device that stores an OTA programming log, encrypt the OTA log, and transmit the encrypted OTA log to a management server 140. For example, the electronic device 100 may rapidly improve a target controller in such a way that the target controller transmits an OTA log including the cause of OTA failure to the management server 140.

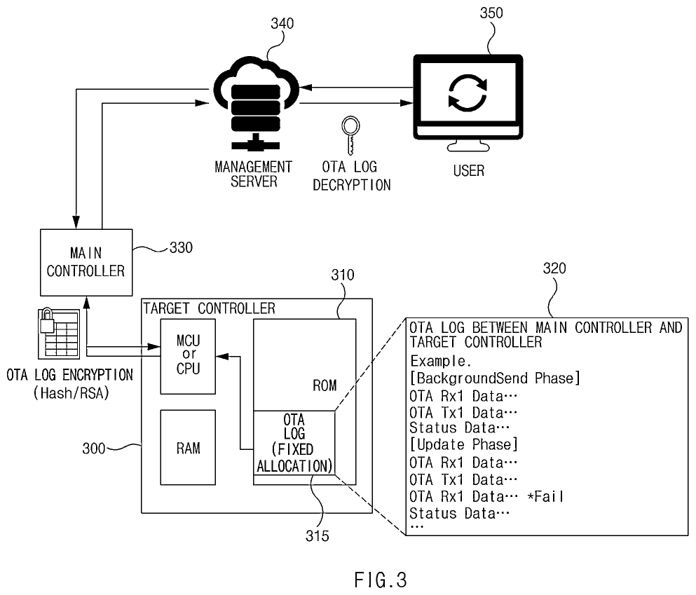

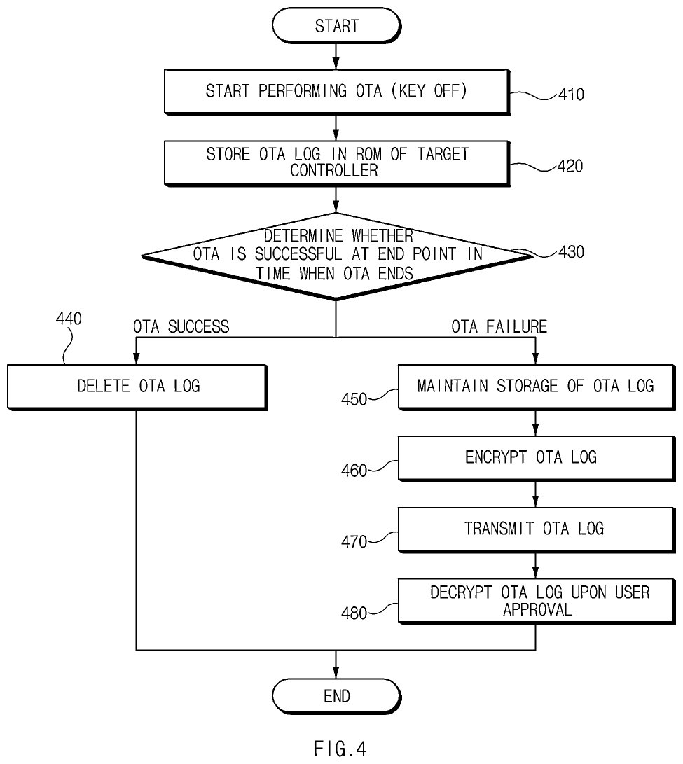

The electronic device 100 may allocate a target area to a memory of the target controller at the start point in time when OTA is performed in the target controller by the main controller. For example, the electronic device 100 may separately allocate a target area to the memory of the target controller to store the OTA log while OTA is performed in the target controller. For reference, in the present specification, for convenience of description, the area allocated to the memory of the target controller is described as being a first target area. A detailed description regarding this will be given below with reference to FIGS. 3 and 4.

The target controller may be a controller included in a vehicle and may refer to a controller that is reprogrammed by OTA. In addition, the main controller may refer to a controller that communicates data for OTA of the target controller with the management server 140. The main controller may be included in a vehicle including the target controller, but is not limited thereto.

The electronic device 100 may store an OTA log containing a communication record between the target controller and the main controller in the target area. For example, the electronic device 100 may store the OTA log in the target area while OTA is performed in the target controller, based on the target area being allocated to the memory of the target controller. A detailed description regarding this will be given below with reference to FIG. 3 and FIG. 4.

The electronic device 100 may transmit the OTA log encrypted by applying the OTA log to an encryption model to the management server 140 based on the failure of the OTA at the end point in time when the OTA performed in the target controller ends. Here, failure of the OTA may indicate that reprogramming by OTA in the target controller has failed. A detailed description regarding this will be given below with reference to FIG. 3 and FIG. 4.

The encryption model may be a model that outputs an encrypted OTA log by applying a public key encryption algorithm (e.g., RSA encryption) or a hash algorithm (e.g., SHA-256 or MD5) to the OTA log. It should be noted that the encryption model is not limited thereto. For example, the encryption model may be a trained model that includes a neural network including at least one layer, each layer including a plurality of nodes. As an example, the encryption model may be a model that applies the OTA log to the input layer and obtains the encrypted OTA log in the output layer through a forward propagation operation.

The processor 110 may execute software and control at least one other component (e.g., hardware or software component) connected to the processor 110. The processor 110 may also perform various data processing or operations. For example, the processor 110 may store the OTA log, encrypted OTA log, vehicle power information, OTA task information, and control information of the target controller in the memory 120.

For reference, the processor 110 may perform all operations to be performed by the electronic device 100. Therefore, for convenience of description, in this specification, operations performed by the electronic device 100 are mainly described as operations performed by the processor 110. Additionally, in the present specification, for convenience of description, the processor 110 is mainly described as being a single processor, but is not limited thereto. For example, the electronic device 100 may include one or more processors. Each of the one or more processors may perform all operations related to operations of storing an OTA log, encrypting the OTA log, and transmitting the encrypted OTA log to the management server 140.

The memory 120 may temporarily and/or permanently store various data and/or information required for the processor 110 to perform operations such as storing the OTA log, encrypting the OTA log, and transmitting the encrypted OTA log to the management server 140. For example, the memory 120 may store OTA logs, encrypted OTA logs, vehicle power information, OTA task information, and control information of the target controller.

The communication device 130 may support communication between the electronic device 100 and the management server 140. For example, the communication device 130 may include one or more components that enable communication between the electronic device 100 and the management server 140. For example, the communication device 130 may include a short range wireless communication unit, a microphone, and the like. In this case, short range communication technology may include wireless LAN (Wi-Fi), Bluetooth, ZigBee, WFD (Wi-Fi Direct), UWB (ultra-wideband), infrared communication (IrDA, infrared Data Association), and BLE (Bluetooth Low Energy), NFC (Near Field Communication), or the like, but is not limited thereto.

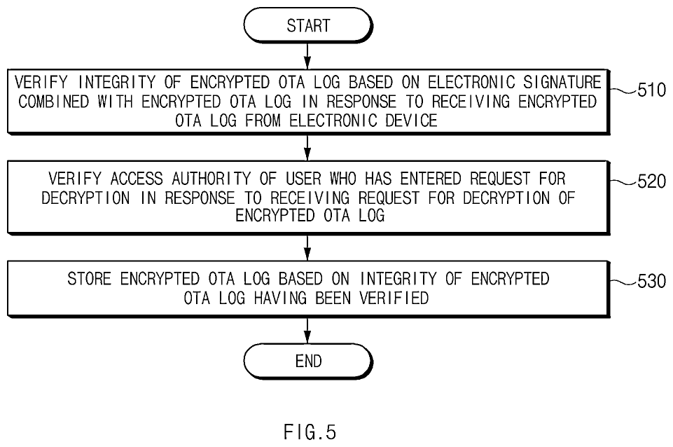

The management server 140 may include a memory that stores computer-executable instructions, at least one processor that accesses the memory and executes the instructions, and a communication device that communicates with the electronic device 100. For reference, the processor included in the management server may be a different processor from the processor 110 included in the electronic device 100, and the memory included in the management server may be a different memory from the memory 120 included in the electronic device 100. The management server 140 may refer to a server that verifies the integrity of an encrypted OTA log received from the electronic device 100 and performs decryption of the encrypted OTA log in response to a user's request. Additionally, the management server 140 may transmit OTA-related data to the main controller for the target controller to perform OTA. Through this, the management server 140 may perform OTA of the target controller and provide the user with the cause of OTA failure based on the OTA failure in the target controller. A detailed description regarding this will be given below with reference to FIG. 5.

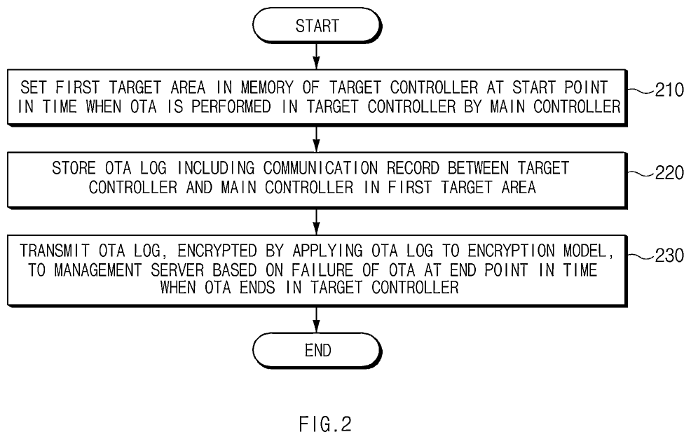

FIG. 2 is a flowchart showing a method of recording an OTA log according to an embodiment of the present disclosure.

In operation 210, an electronic device (e.g., the electronic device 100 of FIG. 1) according to an embodiment may allocate a first target area to a memory of a target controller at the start time when OTA is performed by a main controller in the target controller. For example, the electronic device may allocate a first target area to the memory of the target controller and simultaneously allocate a second target area to the memory of the main controller. The electronic device may perform the following operations by allocating at least one of the first target area or the second target area.

The electronic device may store an OTA log containing a communication record between the target controller and the main controller in the first target area. However, the present disclosure is not limited thereto, and the electronic device may store an OTA log in at least one of the first target area or the second target area. For example, the electronic device may determine an area to store the OTA log based on at least one of the storage capacity of the target controller, the load of the target controller, or the function of the target controller, or any combination thereof. The electronic device may store the OTA log in the determined area.

At the end point in time when OTA performed in the target controller ends, the electronic device may apply the OTA log to an encryption model based on OTA failure and transmit the encrypted OTA log to the management server. For example, based on OTA failure, the electronic device may transmit, to the management server, a first encrypted OTA log obtained by applying a public key encryption algorithm to the OTA log (i.e., apply the OTA log to the encryption model). Additionally, based on OTA failure, the electronic device may transmit, to the management server, a second encrypted OTA log obtained by applying a hash algorithm to the OTA log (i.e., applying the OTA log to an encryption model). Therefore, in the present specification, for convenience of description, it is described that the encrypted OTA log may include both the first encrypted OTA log and the second encrypted OTA log.

The method by which the electronic device transmits the encrypted OTA log to the management server is not limited to this. For example, the electronic device may apply the OTA log encrypted by applying the OTA log to an encryption model to the management server at an intermediate point in time when OTA is performed in the target controller. Here, the intermediate point in time may represent a point in time between a start point in time when OTA begins and an end point in time in which OTA ends. In addition, the electronic device may transmit, to the management server, the OTA log encrypted by applying the OTA log to the encryption model, between the start point in time when OTA is performed in the target controller and the end point in time when OTA ends, regardless of whether the OTA is successful or fails. It should be noted that, in the present specification, it is mainly described that the electronic device transmits the encrypted OTA to the management server in a situation where the OTA fails at the end point in time when OTA ends.

FIG. 3 is a diagram illustrating an electronic device, a management server, an execution controller, and a main controller according to an embodiment of the present disclosure.

An electronic device (e.g., the electronic device 100 of FIG. 1) according to an embodiment may transmit an OTA log 320 stored while OTA is performed in a target controller 300 to a management server 340 via a main controller 330.

The electronic device may allocate a first target area 315 to a memory 310 of the target controller 300 at the start time when OTA is performed by the main controller 330 in the target controller 300. The electronic device may store the OTA log 320, which includes a communication record between the target controller 300 and the main controller 330, in the first target area 315 allocated to the memory 310. It should be noted that the method by which the electronic device stores the OTA log 320 is not limited thereto. For example, the electronic device may set a second target area different from the first target area 315 in the memory of the main controller 330 at the start time when OTA is performed. Before performing communication between the target controller 300 and the main controller 330, the electronic device may determine at least one of the first target area 315, or the second target area, or any combination thereof as an area for storing the OTA log 320. The electronic device may store the OTA log 320 in the determined area.

The OTA log 320 may represent data in which events (e.g., data communication records, etc.) that occur in an event in which reprogramming is performed by OTA in the target controller 300 are recorded. A user 350 may evaluate the reprogramming performed on the target controller 300 by analyzing the OTA log 320. The OTA log 320 may include at least one of a log of download phase, a log of background transfer phase, a log of update phase, or a log of OTA end phase, or any combination thereof. For reference, the log of download phase may include a log about background update, which is a process in which the main controller 330 transmits OTA-related data to the target controller 300. Additionally, the log of the update phase may include a log about foreground update, which is a process in which the target controller 300 is reprogrammed by OTA.

The target controller 300 may perform OTA through request and response communication with the main controller 330. The electronic device may store the OTA log 320, generated while the target controller 300 performs OTA through request and response communication with the main controller 330, in the first target area 315. However, the method of storing the OTA log 320 in the first target area 315 is not limited thereto. For example, the electronic device may obtain status information including at least one of power information of a vehicle including the target controller 300, OTA task information, or control information of the target controller 300, or any combination thereof. The electronic device may store the status information and the OTA log 320 in the first target area 315. That is, the electronic device may store not only the OTA log 320 but also major status information of the target controller 300 in the first target area 315.

The electronic device may transmit, to the main controller 330, an OTA log encrypted by applying the OTA log 320 to an encryption model (not shown) based on the failure of the OTA at the end point in time when the OTA performed in the target controller 300 ends. For example, when OTA has been completed, the electronic device may determine whether the OTA is successful or fails. When the OTA is successful, the electronic device may delete the OTA log 320 stored in the first target area 315. That is, when the OTA fails, the electronic device may permanently store the OTA log 320 in the first target area 315. It should be noted that the method of encrypting the OTA log 320 is not limited thereto. For example, the electronic device may transmit the OTA log 320 to the main controller 330 or the management server 340 and then apply the OTA log 320 to an encryption model.

The electronic device may encrypt the OTA log 320 based on failure of the OTA. For example, the electronic device may obtain at least one of a first encrypted OTA log to which an RSA-type public key encryption algorithm has been applied or a second encrypted OTA log to which a hash algorithm has applied, by applying the encryption models to the OTA log 320. The electronic device may combine an electronic signature capable of verifying integrity with at least one of the first encrypted OTA log, or the second encrypted OTA log, or any combination thereof. The electronic device may transmit the OTA log with the electronic signature combined and encrypted to the management server 340 through the main controller 330.

The management server 340 may receive the encrypted OTA log from the target controller 300 or the main controller 330. The management server 340 may perform verification for the integrity of the encrypted OTA log. The management server 340 may store the encrypted OTA log of which integrity has been verified.

The user 350 may access the management server 340 to analyze OTA failure. For example, the user 350 may access the management server 340 based on the access authority of the user 350 being verified by the management server 340. The user 350 may request the management server 340 to decrypt the encrypted OTA log based on accessing the management server 340. In response to the request for decryption from the user 350, the management server 340 may provide the cause of OTA failure to the user 350 based on the status information of the target controller 300 and the communication record between the target controller 300 and the main controller 330.

FIG. 4 is a flowchart for describing a method for recording an OTA log in an electronic device according to an embodiment of the present disclosure.

In operation 410, an electronic device (e.g., the electronic device 100 of FIG. 1) according to an embodiment may start performing OTA on a target controller based on the ignition of a vehicle including the target controller being finished (e.g., key off).

In operation 420, the electronic device may store the OTA log in a read-only memory (ROM) of a memory of the target controller. For example, the electronic device may allocate a first target area to the ROM of the target controller. The electronic device may store an OTA log containing a communication record between the target controller and the main controller in the allocated first target area.

The electronic device may obtain status information including at least one of power information of a vehicle including the target controller, OTA task information, or control information of the target controller, or any combination thereof. That is, the status information may include information about the status of the target controller on which OTA is performed. The electronic device may store both the status information and the OTA log in the allocated first target area.

In operation 430, the electronic device may determine whether the OTA is successful at the end point in time when the OTA performed in the target controller ends. For example, when reprogramming by the OTA is successful in the target controller, the electronic device may determine that the OTA is successful. Conversely, when reprogramming by OTA fails in the target controller, the electronic device may determine that OTA fails. Specifically, the electronic device may determine whether the OTA is successful, based on at least one of the log of download phase, the log of background transfer phase, the log of update phase, or the log of OTA end phase, or any combination thereof, which is included in the OTA log at the end point in time when the OTA ends.

In operation 440, when the OTA is successful, the electronic device may delete the OTA log including the communication record between the target controller and the main controller stored in the first target area. For example, when the OTA log that the electronic device deletes is an OTA log of interest time point, the electronic device may store the OTA log of the next time point following the target time point in the first target area by deleting the OTA log of the target time point.

In operation 450, when the OTA fails, the electronic device may not delete the OTA log including the communication record between the target controller and the main controller stored in the first target area. In operation 460, the electronic device may encrypt the OTA log. For example, based on the OTA failing and the OTA log not being deleted, the electronic device may obtain a first encrypted OTA log which is included in the encrypted OTA log and to which a public key encryption algorithm has been applied, by applying the OTA log to an encryption model. In operation 460, based on the OTA failing and the OTA log not being deleted, the electronic device may obtain a second encrypted OTA log which is included in the encrypted OTA log and to which a hash algorithm has been applied, by applying the OTA log to an encryption model.

In operation 470, the electronic device may transmit the OTA log to the management server. For example, the electronic device may transmit the first encrypted OTA log to the management server through the main controller. Additionally, the electronic device may transmit the second encrypted OTA log to the management server through the main controller.

The electronic device may combine an electronic signature capable of verifying integrity with at least one of the first encrypted OTA log, or the second encrypted OTA log, or any combination thereof. Therefore, the electronic device may transmit at least one of the first encrypted OTA log with a digital signature combined, or the second encrypted OTA log with a digital signature combined, or any combination thereof to the management server through the main controller.

In operation 480, the encrypted OTA log (e.g., the first encrypted OTA log or the second encrypted OTA log) transmitted to the management server may be decrypted upon user approval by the management server. A detailed description regarding this will be given below with reference to FIG. 5.

FIG. 5 is a flowchart for describing a method of decrypting an encrypted OTA log in a management server according to an embodiment of the present disclosure.

In operation 510, a management server (e.g., the management server 340 of FIG. 3) according to an embodiment may verify integrity of an encrypted OTA log based on a digital signature combined with the encrypted OTA log based on receiving the encrypted OTA log from an electronic device (e.g., the electronic device 100 of FIG. 1).

In operation 520, the management server may verify the access authority of a user who has entered a request for decryption for the encrypted OTA log based on receiving the request for the decryption. For example, the management server may receive an OTA log, an encrypted OTA log, and an electronic signature from the electronic device. The management server may apply a public key encryption algorithm or hash algorithm to the OTA log received from the electronic device. As an example, the management server may obtain a first hash value by applying the hash algorithm to the OTA log.

The management server may decrypt the electronic signature received from the electronic device using the user's access authority, which is a predetermined public key. That is, the user's access authority may be a public key. For example, the management server may decrypt the electronic signature by applying the electronic signature received from the electronic device to the public key to obtain a second hash value.

The management server may verify the integrity of the encrypted OTA log by comparing the first hash value and the second hash value. For example, the management server may finish verification of the integrity of the encrypted OTA log when the first hash value is identical to the second hash value. In contrast, the management server may terminate verification of the integrity of the encrypted OTA log when the first hash value is different from the second hash value.

The management server may obtain the OTA log by decrypting the encrypted OTA log based on the user's access authority, based on the user's access authority being verified. The management server may obtain status information of a target controller corresponding to the OTA log and communication records between the target controller and the main controller, which are included in the OTA log. The management server may provide the user with the cause of OTA failure in the target controller based on the status information and communication records of the target controller in response to the request for the decryption.

In operation 530, the management server may store the encrypted OTA log based on the integrity of the encrypted OTA log being verified. For example, when verification of the integrity of the encrypted OTA log has been finished, the management server may store the encrypted OTA log. In contrast, when verification of the integrity of the encrypted OTA log has been terminated, the management server may not store the encrypted OTA log. Thereafter, the user may quickly find out the cause of the OTA failure just by analyzing the log and promote rapid improvement of the target controller, by analyzing the cause of OTA failure based on the status information and communication records of the target controller received from the management server.

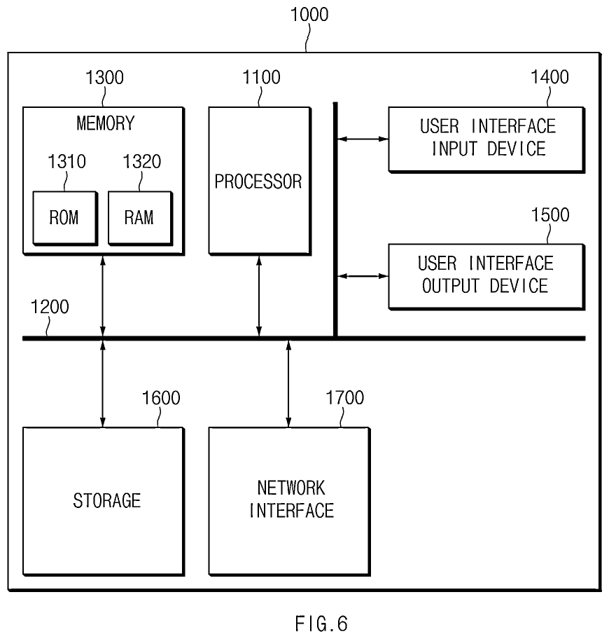

FIG. 6 shows a computing system related to an electronic device, a management server, a control method therefor according to an embodiment of the present disclosure.

Referring to FIG. 6, a computing system 1000 for an electronic device, a management server, a control method may include at least one processor 1100, a memory 1300, a user interface input device 1400, a user interface output device 1500, storage 1600, and a network interface 1700, which are connected with each other via a bus 1200.

The processor 1100 may be a central processing unit (CPU) or a semiconductor device that processes instructions stored in the memory 1300 and/or the storage 1600. The memory 1300 and the storage 1600 may include various types of volatile or non-volatile storage media. For example, the memory 1300 may include a Read Only Memory (ROM) and a Random Access Memory (RAM).

Thus, the operations of the method or the algorithm described in connection with the embodiments disclosed herein may be embodied directly in hardware or a software module executed by the processor 1100, or in a combination thereof. The software module may reside on a storage medium (that is, the memory 1300 and/or the storage 1600) such as a RAM, a flash memory, a ROM, an EPROM, an EEPROM, a register, a hard disk, a removable disk, and a CD-ROM.

The exemplary storage medium may be coupled to the processor 1100, and the processor 1100 may read information out of the storage medium and may record information in the storage medium. Alternatively, the storage medium may be integrated with the processor 1100. The processor and the storage medium may reside in an application specific integrated circuit (ASIC). The ASIC may reside within a user terminal. In another case, the processor and the storage medium may reside in the user terminal as separate components.

The above description is merely illustrative of the technical idea of the present disclosure, and various modifications and variations may be made without departing from the essential characteristics of the present disclosure by those skilled in the art to which the present disclosure pertains.

The embodiments described herein may be implemented with hardware components and software components and/or a combination of the hardware components and the software components. For example, the apparatus, method and components described in the embodiments may be implemented using one or more general-purpose or special purpose computers, such as a processor, a controller and an arithmetic logic unit (ALU), a digital signal processor, a microcomputer, a field programmable array (FPGA), a programmable logic unit (PLU), a microprocessor or any other device capable of executing and responding to instructions. The processing device may run an operating system (OS) and software applications that run on the OS. The processing device also may access, store, manipulate, process, and create data in response to execution of the software. For convenience of understanding, one processing device is described as being used, but those skilled in the art will appreciate that the processing device includes a plurality of processing elements and/or multiple types of processing elements. For example, the processing device may include multiple processors or a single processor and a single controller. In addition, different processing configurations are possible, such a parallel processors.

The software may include a computer program, a piece of code, an instruction, or some combination thereof, for independently or collectively instructing or configuring the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. In particular, the software and data may be stored by computer readable recording mediums.

The above-described methods may be embodied in the form of program instructions that can be executed by various computer means and recorded on a computer-readable medium. The computer-readable medium may include program instructions, data files, data structures, or the like singly or in combination, and the program instructions recorded on the medium may be specially designed and constructed for the embodiments or may be known and available to those skilled in the art of computer software. Examples of computer readable recording media include magnetic media such as hard disks, floppy disks and magnetic tape, optical media such as CD-ROMs, DVDs, and magnetic disks such as floppy disks, Magneto-optical media, and hardware devices specifically configured to store and execute program instructions, such as ROM, RAM, flash memory, and the like. Examples of program instructions include not only machine code generated by a compiler, but also high-level language code that can be executed by a computer using an interpreter or the like.

The hardware device described above may be configured to operate as one or a plurality of software modules to perform the operations of the present disclosure, and vice versa.

Although the embodiments have been described by the limited embodiments and the drawings as described above, various modifications and variations are possible to those skilled in the art from the above description. For example, the described techniques may be performed in a different order than the described method, and/or components of the described systems, structures, devices, circuits, etc. may be combined or combined in a different form than the described method, or other components, or even when replaced or substituted by equivalents, an appropriate result can be achieved.

Therefore, other implementations, other embodiments, and equivalents to the claims are within the scope of the following claims.

Accordingly, the embodiment disclosed in the present disclosure is not intended to limit the technical idea of the present disclosure but to describe the present disclosure, and the scope of the technical idea of the present disclosure is not limited by the embodiment. The scope of protection of the present disclosure should be interpreted by the following claims, and all technical ideas within the scope equivalent thereto should be construed as being included in the scope of the present disclosure.

The effects of the electronic device, the management server, and the control methods thereof according to the present disclosure are given as follows.

According to at least one of the embodiments of the present disclosure, it is possible to store OTA logs in a target area allocated to a memory of a target controller, and analyze the cause of OTA failure in a faster time without the need to conduct unlimited real-time reproduction evaluation of OTA failure events, thereby achieving additional improvements in OTA deployment.

Further, according to at least one of the embodiments of the present disclosure, it is possible to minimize the possibility of hacking through communication of encrypted data between network nodes in view of a vehicle security by transmitting encrypted OTA logs to the management server based on OTA failure at the end point in time when OTA ends.

Further, According to at least one of the embodiments of the present disclosure, it is possible to enable rapid cause analysis without the need for continuous vehicle reproduction evaluation by storing a vehicle's power information, task information, and control information in a target area, and reducing a period during which customers are unable to download new software.

In addition, various effects may be provided that are directly or indirectly understood through the disclosure.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

We claim:

1. An electronic device comprising:
a memory configured to store computer-executable instructions;
at least one processor configured to access the memory and execute the instructions; and
a communication device configured to perform communication with a management server,
wherein the at least one processor is configured to:
allocate a first target area to a memory of a target controller at a start point in time when over-the-air (OTA) programming is performed in the target controller by a main controller,
store an OTA log containing a communication record between the target controller and the main controller in the first target area; and
apply the OTA log to an encryption model and transmit an encrypted OTA log to the management server based on failure of the OTA at an end point in time when the OTA performed in the target controller ends.

2. The electronic device of claim 1, wherein the at least one processor is configured to:
allocate a second target area different from the first target area to a memory of the main controller at the start point in time when the OTA is performed;
determine at least one of the first target area, or the second target area, or any combination thereof as an area for storing the OTA log, before performing communication between the target controller and the main controller; and
store the OTA log in the determined area.

3. The electronic device of claim 1, wherein the at least one processor is configured to:
obtain status information including at least one of power information of a vehicle including the target controller, OTA task information, or control information of the target controller, or any combination thereof; and
store the status information and the OTA log in the first target area.

4. The electronic device of claim 1, wherein the at least one processor is configured to:
determine whether the OTA is successful, based on at least one of a log of download phase, a log of background transfer phase, a log of update phase, or a log of OTA end phase, or any combination thereof, which is included in the OTA log at the end point in time when the OTA ends; and
delete the OTA log stored in the first target area based on the OTA being successful at the end point in time when the OTA ends.

5. The electronic device of claim 1, wherein the at least one processor is configured to:
apply the OTA log to the encryption model to obtain a first encrypted OTA log included in the encrypted OTA log and to which a public key encryption algorithm has been applied based on the OTA failing and the OTA log being stored; and
transmit the first encrypted OTA log to the management server through the main controller.

6. The electronic device of claim 5, wherein the at least one processor is configured to:
apply the OTA log to the encryption model to obtain a second encrypted OTA log included in the encrypted OTA log and to which a hash encryption algorithm has been applied based on the OTA failing and the OTA log being stored; and
transmit the second encrypted OTA log to the management server through the main controller.

7. The electronic device of claim 6, wherein the at least one processor is configured to combine an electronic signature capable of verifying integrity with at least one of the first encrypted OTA log, or the second encrypted OTA log, or any combination thereof.

8. A management server comprising:
a memory configured to store computer-executable instructions;
at least one processor configured to access the memory and execute the instructions; and
a communication device configured to perform communication with an electronic device,
wherein the at least one processor is configured to:
verify integrity of an encrypted OTA log based on an electronic signature combined with the encrypted OTA log based on receiving the encrypted OTA log from the electronic device;
verify an access authority of a user who has entered a request for decryption of the encrypted OTA log based on receiving the request for decryption; and
store the encrypted OTA log based on the integrity of the encrypted OTA log having been verified.

9. The management server of claim 8, wherein the at least one processor is configured to obtain an OTA log by performing decryption of the encrypted OTA log based on the access authority of the user based on the access authority of the user having been verified.

10. The management server of claim 9, wherein the at least one processor is configured to:
obtain status information of a target controller corresponding to the OTA log and a communication record between the target controller and the main controller which are included in the OTA log; and
provide a cause of failure of OTA in the target controller to the user in response to the request for decryption based on the status information of the target controller and the communication record.

11. A control method comprising:
allocating a first target area to a memory of a target controller at a start point in time when performing over-the-air (OTA) programming in the target controller by a main controller;
storing an OTA log containing a communication record between the target controller and the main controller in the first target area; and
applying the OTA log to an encryption model and transmitting an encrypted OTA log to the management server based on failure of the OTA at an end point in time when the OTA performed in the target controller ends.

12. The control method of claim 11, wherein the allocating of the first target area includes
allocating a second target area different from the first target area to a memory of the main controller at the start point in time when the OTA is performed,
determining at least one of the first target area, or the second target area, or any combination thereof as an area for storing the OTA log, before performing communication between the target controller and the main controller, and
storing the OTA log in the determined area.

13. The control method of claim 11, wherein the storing of the OTA log includes
obtaining status information including at least one of power information of a vehicle including the target controller, OTA task information, or control information of the target controller, or any combination thereof, and
storing the status information and the OTA log in the first target area.

14. The control method of claim 11, wherein the storing of the OTA log includes
determining whether the OTA is successful, based on at least one of a log of download phase, a log of background transfer phase, a log of update phase, or a log of OTA end phase, or any combination thereof, which is included in the OTA log at the end point in time when the OTA ends, and
deleting the OTA log stored in the first target area based on the OTA being successful at the end point in time when the OTA ends.

15. The control method of claim 11, wherein the transmitting of the encrypted OTA log to the management server includes
applying the OTA log to the encryption model to obtain a first encrypted OTA log included in the encrypted OTA log and to which a public key encryption algorithm has been applied based on the OTA failing and the OTA log being stored, and
transmitting the first encrypted OTA log to the management server through the main controller.

16. The control method of claim 15, further comprising:
applying the OTA log to the encryption model to obtain a second encrypted OTA log included in the encrypted OTA log and to which a hash encryption algorithm has been applied based on the OTA failing and the OTA log being stored; and
transmitting the first encrypted OTA log to the management server through the main controller.

17. The control method of claim 16, further comprising:
combining an electronic signature capable of verifying integrity with at least one of the first encrypted OTA log, or the second encrypted OTA log, or any combination thereof.

18. The control method of claim 11, further comprising:
verifying integrity of the encrypted OTA log based on an electronic signature combined with the encrypted OTA log based on receiving the encrypted OTA log from an electronic device;
verifying an access authority of a user who has entered a request for decryption of the encrypted OTA log based on receiving the request for decryption; and
storing the encrypted OTA log based on the integrity of the encrypted OTA log having been verified.

19. The control method of claim 18, wherein the verifying of the access authority of the user includes obtaining an OTA log by performing decryption of the encrypted OTA log based on the access authority of the user based on the access authority of the user having been verified.

20. The control method of claim 19, wherein the obtaining of the OTA log includes
obtaining status information of a target controller corresponding to the OTA log and a communication record between the target controller and the main controller which are included in the OTA log, and
providing a cause of failure of OTA in the target controller to the user in response to the request for decryption based on the status information of the target controller and the communication record.
